(19) United States
(12) Patent Application Publication
(10) Pub. No.: US 2022/0000087 A1
(43) Pub. Date: Jan. 6, 2022

(54) Artificial Fishing Lure

(71) Applicant: Salmo Sp. z o.o., Gietrzwald (PL)

(72) Inventor: Piotr Piskorski, Olsztyn (PL)

(73) Assignee: Salmo Sp. z o.o., Gietrzwald (PL)

(21) Appl. No.: 16/921,601

(22) Filed: Jul. 6, 2020

(51) Int. Cl. A01K 85/16

(52) U.S. Cl. CPC A01K 85/16

(57) ABSTRACT

A fishing lure having a lure body with a first portion and a second portion. The lure has a rail extending from the first portion of the lure body to the second portion of the lure body. The rail has a first portion and a second portion. An attachment member is adapted to be combined with the rail and move between the first portion of the rail and the second portion of the rail. In use, when line is being let out of the reel for jigging so there is no upward force on the lure, the attachment member moves toward the front portion of the rail to allow the lure to descend quickly in a downward facing orientation through the water column to a desired depth. Then, upon application of some upward force on the line, the attachment member moves rearward along the rail to the second portion of the rail causing the lure to transition to a horizontal presentation.

### BACKGROUND

A wide variety of fishing tackle exists on the market today. The type of fishing tackle used generally depends upon personal choices of the angler, the species of fish sought, lighting, water conditions, season, availability, fishing style, and other factors. Conventional fishing lures usually have hard or soft plastic bodies formed in the shape of worms, frogs, lizards, minnows, or other creatures or objects, in some instances, the plastic body of the lure is formed with one or more hooks combined therewith. The lure may also include, or be adapted to connect with, other lure components such as leaders, weights, weed guards, spinners, and blades. Alternatively, the plastic lure body can simply be produced by itself, without any other components, in the form of a bait to which the angler adds his/her own hook and/or other lure components.

Different styles of fishing usually require different types of artificial lures. Jigging is one style of fishing wherein a lure is released downward into the water toward the bottom, then moved through the water column in a substantially vertical path by reeling and releasing the line or by moving the tip of the pole upward and downward to create the desired action for attracting fish. One type of common jigging lure consists of a lead sinker with a hook molded into it and is usually covered by a soft body to attract fish. Jigging spoons are also another type of jigging lure. Yet another type of jigging lure is a hard plastic lure which resembles a crankbait, but attaches to the fishing line along the top of the lure instead of the front so as to help maintain a horizontal presentation while jigging. For successful jigging, the jigger needs to stay in contact with the lure and get it to the depth where the fish are located. Most fish caught by jigging are on or near the bottom. One problem with jigging is that it can take some lures a relatively long time to descend from the surface of the water to the bottom where the fish are located, especially hard plastic jigging lures. Another problem with jigging is that jigging lures tend to have less side-to-side or darting action compared with casting lures because jigging lures rely on the vertical rise and fall motion provided by the jigger.

Another style of fishing includes casting the lure outward and retrieving it so the lure moves back toward the caster in a generally horizontal path. Many jigging lures, including hard plastic jigging lures, cannot be used for casting because the attachment point of the fishing line for many jigging lures is on the top of the lure, so reeling the lure along a horizontal path causes the lure to be pulled through the water sideways with its top side leading the way back toward the caster, which is not a natural motion for the lure and is unlikely to attract fish. The same is true when a jigging lure is being pulled behind a boat when trolling.

Sometimes it may be desirable for an angler to switch from a jigging lure to a casting lure relatively quickly. For example, if an angler sees a fish jump at some distance away from the boat while jigging, then the angler may wish to quickly cast a lure in the direction of the fish. Most lures, especially hard plastic lures, are not able to be used for both jigging and casting for the reasons mentioned in the previous paragraph, which means the angler would need to remove the jigging lure and attach a casting lure in order to try to catch the fish spotted in the example given above. Switching lures wastes precious time and allows the fish to swim to an unknown location away from the boat.

There is therefore a need for an improved fishing lure which overcomes these and other problems in the art.

### SUMMARY

One aspect of the invention includes a fishing lure having a lure body with a first portion and a second portion. The first portion may be near a front of the lure body and the second portion may be near a top of the lure body and rearward of the first portion. The lure has a variable attachment point member extending from the first portion of the lure body to the second portion of the lure body. The variable attachment point member has a first portion and a second portion. The first portion of the variable attachment point member may be near a front of the variable attachment point member and the second portion of the variable attachment point member may be near a top of the variable attachment member, which may be rearward and upward of the first portion of the variable attachment member. In some embodiments only one portion of the variable attachment point member is attached to the lure body. In other embodiments both portions of the variable attachment point member are attached to the lure body. A slidable attachment member such as a split ring or swivel is adapted to be combined with the variable attachment point member and move between the first portion of the variable attachment point member and the second portion of the variable attachment member. In use, when line is being let out of the reel for jigging so there is little or no upward force on the lure (i.e., the line is mostly slack), the slidable attachment member similarly does not provide any significant upward force on the variable attachment point member. The lure descends quickly at a downward angle, typically with the first portion of the lure body leading the descent, through the water column to a desired depth. Then, upon application of some upward jigging force on the line such as by flicking the tip of the fishing rod, the slidable attachment member moves to the second portion of the variable attachment point member causing the lure to transition from a downwardly facing descending position to a horizontal presentation. The slidable attachment member moves toward the front portion of the variable attachment point member upon application of a significant and continued force on the lure, such as reeling the lure back to the boat or back to the surface of the water.

Another aspect of the invention includes a fishing lure having a lure body with a first portion and a second portion. The first portion may be near a front of the lure body and the second portion may be near a top of the lure body and rearward of the first portion. The lure has a rail extending from the first portion of the lure body to the second portion of the lure body. The rail has a first portion and a second portion. The first portion of the rail may be near a front of the rail and the second portion of the rail may be near a top of the rail, which may be rearward and upward of the first portion of the rail. In some embodiments only one portion of the rail is attached to the lure body. In other embodiments both portions of the rail are attached to the lure body. An attachment member such as a split ring or swivel is adapted to be combined with the rail and move between the first portion of the rail and the second portion of the rail. In this manner, the rail functions as a variable attachment point for the attachment member. In use, when line is being let out of the reel for jigging so there is little or no upward force on the lure (i.e., the line is mostly slack), the attachment member similarly does not provide any significant upward force on the rail. During descent, the attachment member may migrate to any portion of the rail, however, the attachment member usually moves toward the second portion of the rail since the lure typically descends with the first portion of the lure leading the descent (head first). The lure descends quickly at a downward angle through the water column to a desired depth. Then, upon application of some upward force on the line such as by flicking the tip of the fishing rod, the attachment member moves along the rail to the second portion of the rail thereby applying upward force on the second portion of the rail causing the lure to transition from a vertical descending position to a horizontal presentation. The attachment member typically remains at the second portion of the rail while the lure body rises and falls in the water column as a result of the angler's pigging motion. However, the attachment member may also slide along the rail during jigging. This means the upward force produced by the angler may act on the lure along different points of the rail, which makes the action of the lure unpredictable and attractive to fish. The attachment member moves toward the front portion of the rail upon application of a significant and continued force on the lure, such as reeling the lure back to the boat or back to the surface of the water.

Another aspect of the invention includes a fishing lure having lure body with a first portion and a second portion. The first portion may be near a front of the lure body and the second portion of the lure may be near a top of the lure body and rearward of the first portion. The lure has a rail extending from the first portion of the lure body to the second portion of the lure body. The rail has a first portion and a second portion. The first portion of the rail may be near a front of the rail and the second portion of the rail may be near a top of the rail, which may be rearward and upward of the first portion of the rail. In some embodiments only one portion of the rail is attached to the lure body. In other embodiments both portions of the rail are attached to the lure body. The rail includes a front detent near the first portion of the rail and a top detent near the second portion of the rail. An attachment member such as a split ring or swivel is adapted to be combined with the rail and move between the front detent and the top detent. Each detent comprises an area of the rail where the angle of the rail changes to help selectively secure the attachment member in the detent upon application of certain force or lack of force on the attachment member. In some embodiments, each detent is an area of the rail where the rail has a notch or curved or angled contour adapted to receive the attachment member. In this manner, the rail functions as a variable attachment point for the attachment member. In use, when line is being let out of the reel for jigging so there is little or no upward force on the lure (i.e., the line is mostly slack), the attachment member similarly does not provide any significant upward force on the rail. During descent, the attachment member may migrate to any portion of the rail, however, the attachment member usually moves toward the second portion of the rail since the lure typically descends with the first portion of the lure leading the descent (head first). The lure descends quickly through the water column at a downward angle to a desired depth. Then, upon application of some upward force on the line such as by flicking the tip of the fishing rod, the attachment member moves along the rail to the top detent of the rail thereby applying upward force on the second portion of the rail (top detent) causing the lure to transition from a vertical descending position to a horizontal presentation. The attachment member typically remains at the second portion of the rail (near the top detent) while the lure body rises and falls in the water column as a result of the angler's jigging motion. However, the attachment member may also slide along the rail during jigging. This means the upward force produced by the angler may act on the lure along different points of the rail, which makes the action of the lure unpredictable and attractive to fish. The attachment member moves toward the front portion of the rail upon application of a significant and continued force on the lure, such as reeling the lure back to the boat or back to the surface of the water.

In some embodiments the center of mass of the lure is located below the first portion of the lure body and behind the second portion of the lure body. In some embodiments the center of mass is located below the first portion of the rail and behind the second portion of the rail. In some embodiments the center of mass of the lure is located below the front detent and behind the top detent. In some embodiments a load or weight is combined with the lure body, for example, inside the lure body, to create the desired center of mass.

In some embodiments the lure may further include one or more hooks or other lure components combined with the lure body.

In some embodiments the lure may further include a lip, bib, or bill (collectively referred to herein as a “bib”) combined with the first portion of the lure body. The bib helps provide lateral wobble action for the lure when being jigged vertically or when being retrieved from a cast laterally through the water.

Another aspect of the invention includes a method of fishing using a fishing lure. The method includes taking a fishing lure having a lure body with a first portion and a second portion. The lure having a rail extending from the first portion of the lure body to the second portion of the lure body, the rail having a first portion a second portion. The lure further having an attachment member movably combined with the rail between the first portion of the rail and the second portion of the rail. Attaching a fishing line to the attachment member then lowering the lure into the water so there is little or no upward force on the lure (i.e., the line is mostly slack) and the attachment member similarly does not provide any significant upward force on the rail to allow the lure to descend quickly at a downward angle through the water column to a desired depth. During descent, the attachment member may migrate to any portion of the rail, however, the attachment member usually moves toward the second portion of the rail since the lure typically descends with the first portion of the lure leading the descent (head first). Then, applying some upward force on the line such as by flicking the tip of the fishing rod thereby causing the attachment member to move along the rail to the second portion of the rail and apply an upward force on the second portion of the rail causing the lure to transition to a horizontal presentation. The attachment member typically remains at the second portion of the rail while the lure body rises and falls in the water column as a result of the angler's jigging motion. However, the attachment member may also slide along the rail during jigging. This means the upward force produced by the angler may act on the lure along different points of the rail, which makes the action of the lure unpredictable and attractive to fish. The attachment member moves toward the front portion of the rail upon application of a significant continued force on the lure, such as reeling the lure back to the boat or back to the surface.

### BRIEF DESCRIPTION OF THE DRAWINGS

FIG. 1 is a perspective view of the lure.

FIG. 2 is a side view of the lure showing a weight combined with the lure body.

FIG. 3 is a side view of lure descending downward.

FIG. 4 is a side view of the lure in a transitional presentation.

FIG. 5 is a side view of the lure in a horizontal presentation when jigging.

FIG. 6 is a top view of the lure.

FIG. 7 is a side view of the lure in a horizontal presentation when casting.

### DETAILED DESCRIPTION

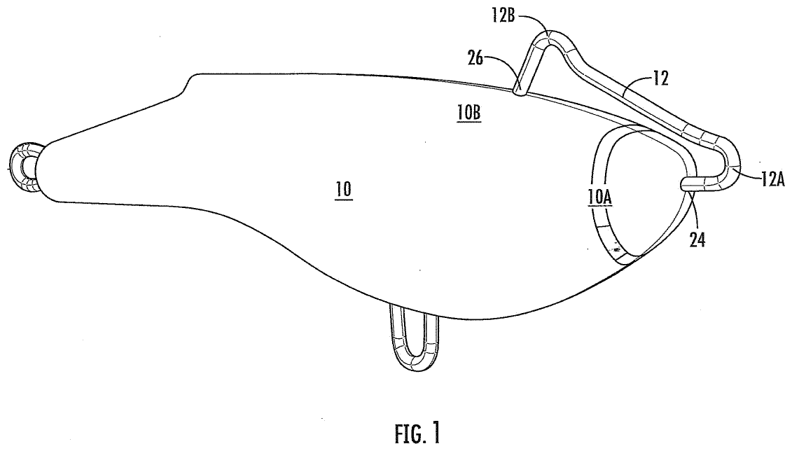

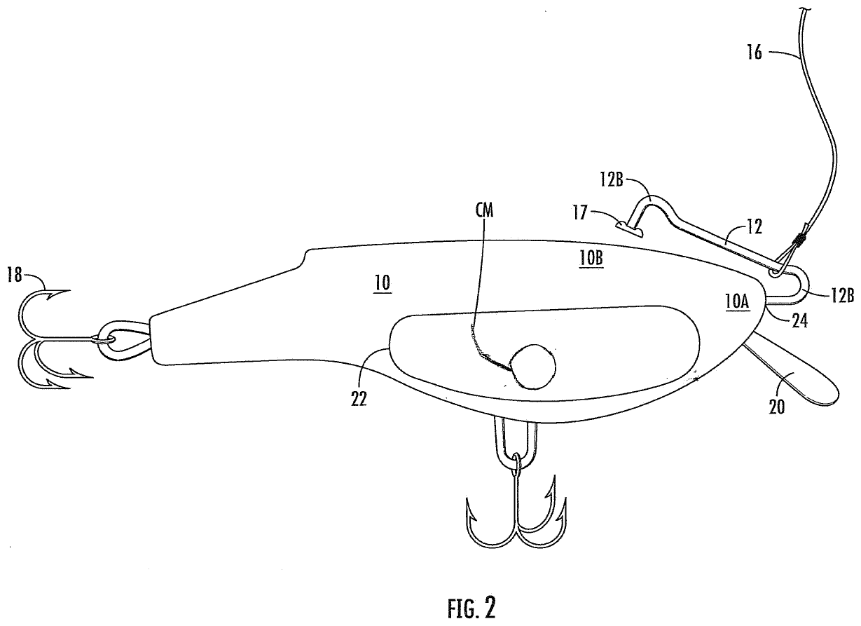

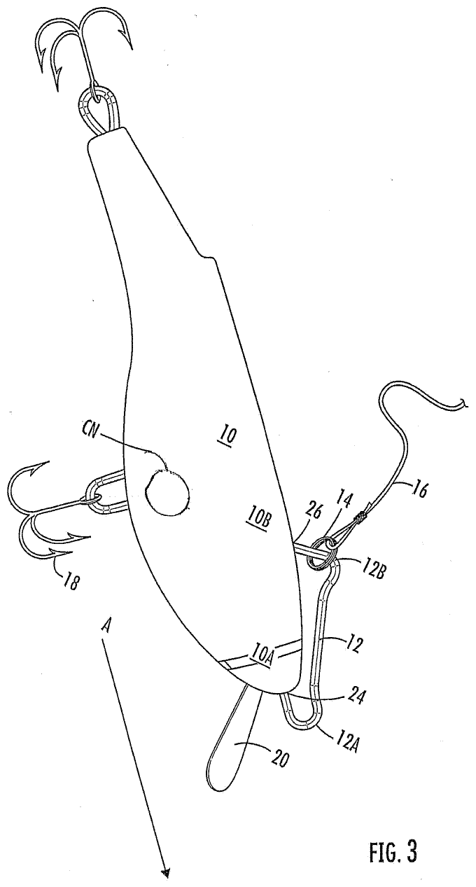

FIG. 1 is a perspective view of an embodiment of the fishing lure according to the present invention. The fishing lure includes a lure body 10 having a first portion 10A and a second portion 10B. The first portion 10A may be near a front of the lure body 10 and the second portion 10B may be near a top of the lure body 10 and is also rearward of the first portion. In other embodiments the first portion 10A and second portion 10B of the lure body 10 may be moved rearward or combined with other areas of the lure body 10. The lure has a variable attachment point member such as a rail 12 extending from the first portion 10A of the lure body 10 to the second portion 10B of the lure body 10. The rail 12 has a first portion and a second portion. The first portion of the rail 12 may be near a front of the rail 12 and the second portion of the rail 12 may be near a top of the rail 12, which may be rearward and upward of the first portion of the rail 12. In the embodiment shown in FIGS. 1 and 3, the first portion of the rail 12 is combined with the first portion 10A of the lure body 10 at a first attachment point 24 and the second portion of the rail 12 is combined with the second portion 10B of the lure body 11 at a second attachment point 26. In other embodiments like the one shown in FIG. 2, only one of the two attachment points 24, 26 is necessary to support the connection between the rail 12 and the lure body 10. In other words, the rail 12 is only combined with the lure body 10 at one of its ends. In these embodiments the end of the rail 12 that is not attached to the lure body 10 includes a retainer member 17 to help keep the attachment member 14 from sliding off the unattached end of the rail 12. The retainer member 17 may be a bulbous portion of the rail 12 or a ring or washer having a diameter larger than the inside diameter of the attachment member 14. In some embodiments the rail 12 is directly connected to the lure body 10, in other embodiments the rail 12 is indirectly combined with the lure body 10 through other components.

An attachment member 14 such as a ring, split ring, or swivel is adapted to be combined with the rail 12 and move between various points on the rail 12. In this manner the rail 12 functions as a variable attachment point for the attachment member 14/fishing line 16. In some embodiments the rail 12 is spaced from the lure body 10 as shown in FIG. 1 so the attachment member 14 is able to slide along the rail 12 between the lure body 10 and the rail 12 as shown in FIGS. 3-5. In some embodiments the rail 12 is spaced from an outside surface of the lure body 10 generally along the front of the top portion of the lure body 10 as shown in FIG. 1 so the attachment member 14 is able to slide along the rail 12 between the lure body 10 and the rail 12 as shown in FIGS. 3-5. In still other embodiments the lure body 10 includes an elongated opening therein and some or all of the rail 12 is positioned within the opening in order to help hide the rail 12 so the lure looks more real and natural. In the embodiments where the rail 12 is recessed within the lure body 10, the attachment member 14 is able to slide along the rail 12 like in the embodiments described above.

The attachment member 14 is also adapted to be combined with fishing line 16 so the attachment member 14 combines the fishing line 16 and the lure. It should be noted that in some embodiments the fishing line 16 may be attached directly to the rail 12 without any intermediate attachment member 14 as shown in FIG. 2. In these embodiments the fishing line 16 is made of a material or tied to the rail 12 in such a way that the line 16 is capable of sliding along the rail 12 between the first portion of the rail 12 and the second portion of the rail 12 without undue friction between the line 16 and the rail 12.

In some embodiments the rail 12 includes a front detent 12A and/or a top detent 12B as shown in FIG. 1. The attachment member 14 is adapted to move along the rail 12 between the front detent 12A and the top detent 12B. Each detent 12A, 12B comprises an area of the rail 12 where the angle of the rail 12 changes, where the rail 12 ends, or where the rail 12 is attached to the lure body 10 to help selectively secure the attachment member 14 in the detent 12A, 12B upon the application of certain force or lack of force on the attachment member 14. In some embodiments, like the ones shown in FIGS. 1-5, each detent 12A,12B is an area of the rail 12 where the rail 12 has a notch or curved or angled contour adapted to receive and temporarily retain the attachment member 14 until the amount or direction of force changes.

As explained below in more detail, in some embodiments the shape of the lure body 10 and center of mass CM help with the orientation or the lure in the water and movement of the attachment member 14 along the rail 12. As shown in FIGS. 2 and 3, in some embodiments, the center of mass CM of the lure is located below the first portion 10A of the lure body 10 and behind the second portion 108 of the lure body 10. In some embodiments the center of mass CM of the lure is located below the first attachment point 24 and behind the second attachment point 26. In some embodiments the center of mass CM is located below the first portion of the rail 12 and behind the second portion of the rail 12. In some embodiments the center of mass CM of the lure is located below the front detent 12A and behind the top detent 12B. In some embodiments the center of mass of the lure is located below the first portion 10A of the lure body and behind the second portion 10B of the lure body. In some embodiments the center of mass CM of the lure is located closer to the first portion (front) of the lure body than a rear portion of the lure body. As shown in FIG. 2, in some embodiments a load or weight 22 is combined with the lure body 10, for example, inside the lure body 10, to create the center of mass CM at the desired location.

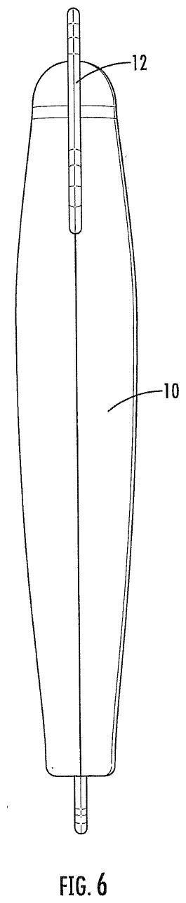

FIGS. 3-5 illustrate the movement of the lure body 10 through the water and movement of the attachment member 14 along the rail 12. FIG. 3 shows the lure descending downward through the water column in the direction of arrow A where its first portion or head is pointed generally downward. As shown best in FIGS. 3 and 6, in some embodiments the lure has a hydrodynamic shape which helps it descend quickly. The positioning of the center of mass CM as described in the previous paragraph helps cause the lure body 10 to descend head first at a downward angle. In some embodiments the lure descends with its first portion leading the descent at an angle of about 180° (relative to the upwardly extending fishing line) so the descent is generally vertical. In other embodiments the lure descends with its first portion leading the descent at an angle of about between 130° to 170°. In some embodiments the lure descends with its first portion leading the descent at an angle of about 140° to 160°. As the lure descends downward, the line 16 is mostly slack so there is little or no upward force being applied to the rail 12 and/or attachment member 14. During descent the attachment member 12 may be positioned anywhere along the rail, however, it typically remains at or near the second portion of the rail 12 as shown in FIG. 3.

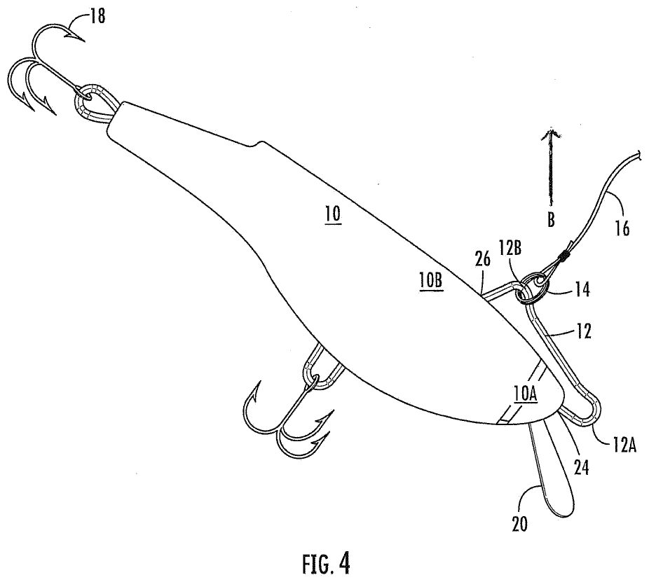

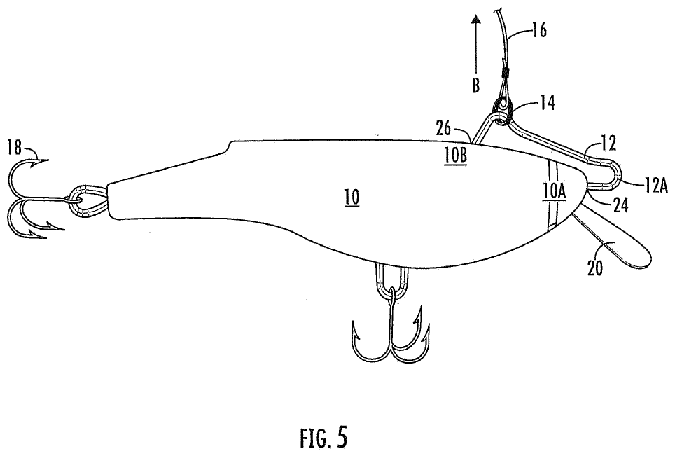

Upon reaching the desired depth, the angler applies some upward force to the rail 12 and/or attachment member 14 by reeling the line 16 or flicking the tip of the fishing rod. The application of upward force along the vertical axis is shown by arrow Bin FIG. 4 whereupon the attachment member 14 begins to move along the rail 12 and provide upward force to the second portion of the rail (top detent 128 in some embodiments) causing the lure body 10 to transition (FIG. 4) from a downwardly angled orientation to a horizontal orientation as shown in FIG. 5. The drag of the lure body 10 upward against the water helps the attachment member 14 to move along the rail 12 to the second portion of the rail 12 as the upward jigging force is applied. Now, at the second portion of the rail 12 (which may be in the top detent 12B) upward force is applied to the top of the lure body 10 helping the lure to remain in a horizontal orientation during jigging. The attachment member 14 typically remains at the second portion (or top detent 12B) of the rail 12 with the lure body 10 in its generally horizontal presentation while the lure body 10 rises and falls in the water column as a result of the angler's Jigging motion. Each time the angler gives the line 16 some slack to let the lure descend during jigging, the lure descends nose first at a downward angle as shown in FIG. 3 and described in the previous paragraph. Then, the angler's upward jigging force causes the attachment member 14 to pull the lure upward from a point along the second portion of the rail (or top detent 128) which brings the lure back to its horizontal presentation. In this manner, the lure “walks” forward through the water descending downwardly and forwardly then darting back up to a generally horizontal presentation with the attachment member 14 along the top or second portion of the rail 12.

In some embodiments the attachment member 14 may slide along the rail 12 during jigging. This means the upward force produced by the angler may act on the lure along different points of the top portion of the rail 12, which makes the action of the lure unpredictable and attractive to fish.

The attachment member moves toward the front portion of the rail upon application of a significant and continued force on the lure, such as reeling the lure back to the boat or back to the surface.

As shown in FIGS. 2-5, in some embodiments the lure may further include one or more hooks 18 or other lure components combined with the lure body 10.

As shown in FIGS. 2-5, in some embodiments the lure may further include a lip, bib, or bill (collectively referred to herein as a “bib” 20) combined with the first portion 10A of the lure body 10. The bib 20 helps provide lateral wobble action for the lure even when being jigged vertically or when being retrieved from a cast laterally through the water.

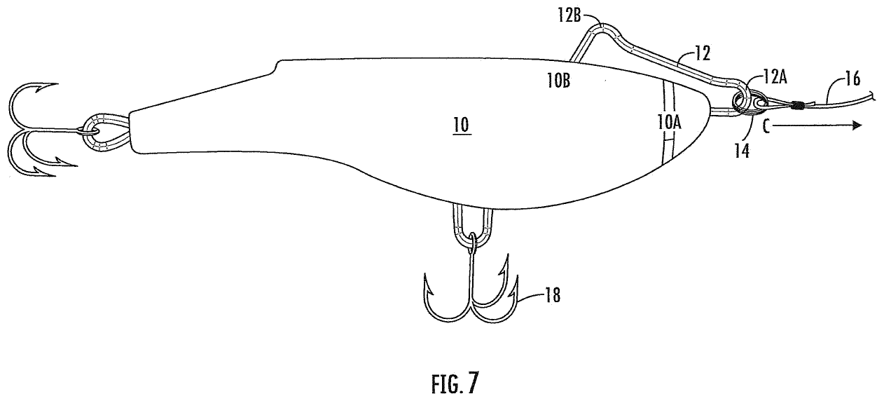

In addition to jigging, the lure of the present invention may also be used when casting or trolling because the variable attachment point (rail 12 in some embodiments) allows the attachment member 14 to move forward along the rail 12 toward the front of the lure body 10 when force is applied along the longitudinal axis in the direction of arrow C. FIG. 7 shows an embodiment wherein the lure is being retrieved after being casted some distance away from the angler or where the lure is being pulled behind a boat while trolling. The drag on the lure body 10 through the water causes tension on the line 16 in the direction of arrow C. This causes the attachment member 14 to move toward the first portion of the rail 12 or be retained within the front detent 12A in some embodiments. Continued force along the longitudinal axis causes the lure body 10 to move through the water in a horizontal orientation as shown in FIG. 7. The lure body 10 is pulled through the water from the first portion of the rail 12 so the first portion 10A of the lure body 10 leads the lure through the water in a horizontal orientation.

Having thus described the invention in connection with the preferred embodiments thereof, it will be evident to those skilled in the art that various revisions can be made to the preferred embodiments described herein with out departing from the spirit and scope of the invention. It is my intention, however, that all such revisions and modifications that are evident to those skilled in the art will be included with in the scope of the following claims. It should be noted that as used herein, relative positional terms such as “top” and “upward” refer to the lure body 10 in its horizontal presentation as shown in FIG. 5, “front” refers to the leading portion when the lure is being retrieved from a cast, and “rearward” refers to the portion that sinks first and/or the portion opposite of the “front.”

What is claimed is as follows:

1. A fishing lure comprising:
a lure body having a first portion and a second portion;
a variable attachment point member combined with the lure body, the variable attachment point member having a first portion and a second portion;
a slidable attachment member combined with the variable attachment point member and moveable between the first portion of the variable attachment point member and the second portion of the variable attachment point member.

2. The fishing lure of claim 1 wherein the variable attachment point member is a rail.

3. The fishing lure of claim 1 wherein only one of the first portion of the variable attachment point member and the second portion of the variable attachment point member is combined with the lure body.

4. The fishing lure of claim 1 wherein the variable attachment point member is directly combined with the lure body.

5. The fishing lure of claim 1 wherein the lure body has an outside surface and the variable attachment point member is spaced from the outside surface of the lure body.

6. The fishing lure of claim 1 wherein the lube body includes an opening therein and the variable attachment point member is recessed within the opening.

7. The fishing lure of claim 1 wherein the first portion of the lure body is near a front of the lure body and the second portion of the lure body is near a top of the lure body.

8. A fishing lure comprising:
a lure body having a first portion and a second portion; and
a rail extending from the first portion of the lure body to the second portion of the lure body, wherein the rail has a first portion and a second portion.

9. The fishing lure of claim 8 further comprising an attachment member combined with the rail and moveable between the first portion of the rail and the second portion of the rail.

10. The fishing lure of claim 9 wherein the rail further comprises a front detent near the first portion of the rail to selectively retain the attachment member therein.

11. The fishing lure of claim 9 wherein the rail further comprises a top detent to selectively retrain the attachment member therein.

12. The fishing lure of claim 8 wherein the first portion of the lure body is near a front of the lure body and the second portion of the lure body is near a top of the lure body.

13. The fishing lure of claim 8 wherein the first portion of the rail is near a front of the rail and the second portion of the rail is near a top of the rail, which is rearward and upward of the first portion.

14. The fishing lure of claim 8 wherein the first portion of the rail is combined with the first portion of the lure body at a first attachment point and the second portion of the rail is combined with the second portion of the lure body at a second attachment point.

15. The fishing lure of claim 8 wherein only one of the first portion of the rail and the second portion of the variable attachment point member is combined with the lure body.

16. The fishing lure of claim 8 wherein the rail is directly combined with the lure body.

17. The fishing lure of claim 8 wherein the lure body has an outside surface and the rail is spaced from the outside surface of the lure body.

18. The fishing lure of claim 8 wherein the lube body includes an opening therein and the rail is recessed within the opening.

19. The fishing lure of claim 8 further comprising a bib combined with the first portion of the lure body.

20. The fishing lure of claim 8 further comprising a center of mass, wherein the center of mass is located below the first portion of the lure body and behind the second portion of the lure body.

21. The fishing lure of claim 8 further comprising a center of mass, wherein the center of mass is located below the first portion of the rail and behind the second portion of the rail.

22. The fishing lure of claim 8 further comprising a center of mass, wherein the center of mass is located below the front detent and behind the top detent.

23. The fishing lure of claim 8 further comprising a load inside the lure body to create a desired center of mass.

24. The fishing lure of claim 8 further comprising one or more hooks combined with the lure body.

25. The fishing lure of claim 8 wherein the lure body further comprises a front portion and a rear portion and the rear portion is narrower than the front portion.

26. A fishing lure comprising:
a lure body having a first portion and a second portion;
a rail extending from the first portion of the lure body to the second portion of the lure body, wherein the rail has a first portion and a second portion;
wherein the first portion of the rail is combined with the first portion of the lure body at a first attachment point and the second portion of the rail is combined with the second portion of the lure body at a second attachment point;
an attachment member combined with the rail and moveable between the first portion of the rail and the second portion of the rail;
a center of mass, wherein the center of mass is located below the first portion of the rail and behind the second portion of the rail;
one or more hooks combined with the lure body; and
a bib combined with the first portion of the lure body.

27. A method of fishing comprising:
taking a fishing lure having a lure body with a first portion, a second portion, and a head, a rail extending from the first portion of the lure body to the second portion of the lure body, and an attachment member, wherein the rail has a first portion and a second portion and the attachment is movable between the first portion of the rail and the second portion of the rail;
attaching a fishing line to the attachment member;
lowering the fishing lure into the water so there is no upward force on the lure causing the lure body to descend head first;
upon reaching a desired depth, applying some upward force on the attachment member through the fishing line causing the attachment member to move along the rail to the second portion of the rail thereby transitioning the lure from a downward facing orientation to a horizontal orientation.

28. The method of claim 27 further comprising, casting the lure a distance without removing the fishing line from the attachment member;
reeling the line so the attachment member moves toward the front portion of the rail and pulls the lure back in a horizontal orientation.
